(19) United States
(12) Patent Application Publication
(10) Pub. No.: US 2026/0296113 A1
(43) Pub. Date: Oct. 1, 2026

(54) CLAMP DEVICE AND CARRYING VEHICLE

(71) Applicant: EXEDY Corporation, Osaka (JP)

(72) Inventor: Shin INOUE, Osaka (JP)

(21) Appl. No.: 19/549,908

(22) Filed: Feb. 25, 2026

(30) Foreign Application Priority Data
Mar. 25, 2025 (JP) 2025-049649

(51) Int. Cl. B60D 1/01; A61G 5/04; B60D 1/00

(52) U.S. Cl. CPC B60D 1/01; A61G 5/041; B60D 2001/005

(57) ABSTRACT

A clamp device includes a base unit, a first clamp member, a second clamp member, and a toggle mechanism. The first clamp member includes a pressure receiving surface oriented upward or downward. The first clamp member is attached to the base unit in an immovable manner. The second clamp member includes a pressure supplying surface opposed to the pressure receiving surface. The second clamp member is attached to the base unit to be movable up and down. The toggle mechanism is configured to move the second clamp member up and down. Thus, the clamp device reliably clamps an object.

### CROSS-REFERENCE TO RELATED APPLICATIONS

This application is based on and claims the priority benefit of Japanese application No. 2025-049649 filed on Mar. 25, 2025, the contents of which are incorporated herein by reference.

### TECHNICAL FIELD

The present invention relates to a clamp device and a carrying vehicle.

### BACKGROUND

A carrying vehicle, such as an electric towing vehicle, an automated guided vehicle (AGV), or so forth, is configured to tow and to carry a carried vehicle such as a cart, see, e.g., Japan Laid-open Patent Application Publication No. 2018-108795. The carrying vehicle includes a joint device so as to be joinable to a variety of carried vehicles.

As exemplified by the joint mechanism described above, a clamp device can be configured to clamp a carried vehicle such that the carrying vehicle is easily joinable to and detachable from the carried vehicle. There is a demand for clamp devices that more reliably clamp carried vehicles than those currently provided.

### SUMMARY OF THE INVENTION

It is an object of the present invention to provide a clamp device that is enabled to reliably clamp an object.

A clamp device according to a first aspect includes a base unit, a first clamp member, a second clamp member, and a toggle mechanism. The first clamp member includes a pressure receiving surface oriented upward or downward. The first clamp member is attached to the base unit in an immovable manner. The second clamp member includes a pressure applying surface opposed to the pressure receiving surface. The second clamp member is attached to the base unit so that it is movable up and down. The toggle mechanism is configured to move the second clamp member up and down.

According to this configuration, the toggle mechanism moves the second clamp member up and down so that it is possible to clamp an object by the pressure receiving surface of the first clamp member and the pressure applying surface of the second clamp member. Because of this, it is possible to reliably clamp the object. Further, the object is clamped in the up-and-down direction by the pressure applying surface and the pressure receiving surface; hence, the clamp device can be prevented from twisting and rising on one side in the width direction.

A clamp device according to a second aspect relates to the clamp device according to the first aspect and is configured as follows. The toggle mechanism includes a first link, a second link, and a joint. The first link is attached to the base in a pivotable manner. The second link is attached to the second clamp member in a pivotable manner. The joint joins the first and second links therethrough to each other.

A clamp device according to a third aspect relates to the clamp device according to the second aspect and is configured as follows. The second link includes a first end portion and a second end portion. The first end portion is attached to the second clamp member in a pivotable manner. The second end portion is joined to the first link through the joint. The first link includes a first arm and a second arm. The first arm extends from a first pivot axis of the first link and is joined to the second end portion of the second link through the joint. The second arm extends from the first pivot axis in a different extending direction from the first arm.

A clamp device according to a fourth aspect relates to the clamp device according to the third aspect and further includes an operating member. The operating member is attached to a distal end portion of the second arm. The operating member is configured to pivot the first link.

A clamp device according to a fifth aspect relates to the clamp device according to the second or third aspect and further includes an operating member configured to pivot the first link.

A clamp device according to a sixth aspect relates to the clamp device according to any of the second to fifth aspects and is configured as follows. The toggle mechanism is switchable between an actuated state and an unactuated state. The toggle mechanism causes the pressure applying surface to press the pressure receiving surface when set in the actuated state. The toggle mechanism releases the pressure applying surface from pressing the pressure receiving surface when set in the unactuated state. The joint is disposed on a first side of an imaginary reference line when the toggle mechanism is set in the unactuated state. It should be noted that the imaginary reference line is defined as an imaginary line connecting a first pivot axis of the first link and a second pivot axis of the second link. The joint is disposed either on the imaginary reference line or on a second side of the imaginary reference line when the toggle mechanism is set in the actuated state.

A clamp device according to a seventh aspect relates to the clamp device according to the sixth aspect and further includes a lock mechanism. The lock mechanism is configured to keep the toggle mechanism in the actuated state.

A clamp device according to an eighth aspect relates to the clamp device according to the seventh aspect and is configured as follows. The lock mechanism includes a stopper portion. The stopper portion is configured to restrict the first link from pivoting in a direction so as not to move the joint past the imaginary reference line to the second side.

A clamp device according to a ninth aspect relates to the clamp device according to the eighth aspect and further includes an unlock mechanism. The unlock mechanism is configured to allow the first link to pivot in another direction so as to move the joint to the first side of the imaginary reference line.

A clamp device according to a tenth aspect relates to the clamp device according to any of the second to ninth aspects and further includes a guide member. The guide member includes a guide groove extending in an up-and-down direction. The guide member is attached to the base unit in an immovable manner. The second link includes a protruding portion configured to be moved along the guide groove in the up-and-down direction.

A clamp device according to an eleventh aspect relates to the clamp device according to any of the first to tenth aspects and further includes an urging member. The urging member urges the second clamp member such that the pressure applying surface is separated away from the pressure receiving surface.

A clamp device according to a twelfth aspect relates to the clamp device according to any of the first to eleventh aspects and is configured as follows. The base unit includes a first holding surface extending to be orthogonal to the pressure receiving surface. The second clamp member includes a second holding surface opposed to the first holding surface at an interval.

A clamp device according to a thirteenth aspect relates to the clamp device according to any of the first to twelfth aspects and is configured as follows. The second clamp member includes a slider, a clamp body, and a spacer. The slider is attached to the base unit so that it is movable up and down. The clamp body includes the pressure applying surface. The spacer is disposed between the clamp body and the slider. The spacer is attached to the clamp body and the slider to be detachable therefrom.

A clamp device according to a fourteenth aspect relates to the clamp device according to any of the first to thirteenth aspects and is configured as follows. The second clamp member includes a slider and a clamp body. The slider is attached to the base unit in a manner to be movable up and down. The clamp body includes the pressure applying surface and is attached to the slider in a manner to be adjustable in positions in an up-and-down direction.

A carrying vehicle according to a fifteenth aspect includes a carrying vehicle body and the clamp device recited in any of the first to fourteenth aspects. The carrying vehicle body includes a prime mover and a drive wheel. The clamp device is attached to the carrying vehicle body.

Overall, according to the present invention, a device is provided to reliably clamp an object.

### BRIEF DESCRIPTION OF THE DRAWINGS

FIG. 1 is a side view of a carrying vehicle according to a preferred embodiment.

FIG. 2 is a side view of the carrying vehicle, from which a frame is detached in part for illustrative purposes.

FIG. 3 is a front view of a clamp device of the carrying vehicle by which an object has not been clamped.

FIG. 4 is a rear view of the clamp device by which the object has not been clamped.

FIG. 5 is a side view of the clamp device by which the object has not been clamped.

FIG. 6 is a rear view of the clamp device by which the object has been clamped.

FIG. 7 is a front view of the clamp device by which the object has been clamped.

FIG. 8 is a side view of the clamp device by which the object has been clamped.

### DETAILED DESCRIPTION

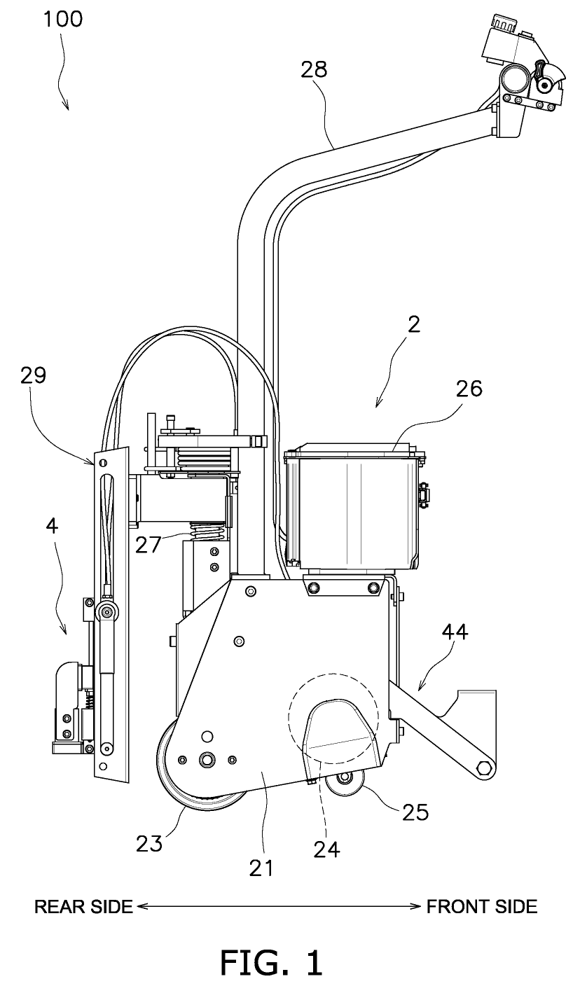

A clamp device 4 according to the present preferred embodiment, and a carrying vehicle 100, in which the clamp device 4 is installed, will be hereinafter explained with reference to the drawings. It should be noted that in the following explanation, the term “front” refers to a direction that the carrying vehicle 100 is moved while towing a carried vehicle (omitted in illustration), whereas the term “rear” refers to a direction that the carrying vehicle 100 is moved while pushing the carried vehicle. In other words, the right side in FIG. 1 corresponds to the front side, whereas the left side in FIG. 1 corresponds to the rear side. Further, the term “width direction” refers to a direction oriented orthogonal to the drawing of FIG. 1. The up and down or upward and downward directions extend orthogonally to the front and rear and width directions.

### Carrying Vehicle

FIG. 1 is a side view of the carrying vehicle 100. It should be noted that FIG. 1 shows the carrying vehicle 100 in which the clamp device 4 is set in a clamping state even though it is not joined to the carried vehicle. As shown in FIG. 1, the carrying vehicle 100 is configured to be joined to the carried vehicle so as to tow the carried vehicle. It should be noted that the carried vehicle is disposed on the rear side (the left side in FIG. 1) of the carrying vehicle 100.

The carrying vehicle 100 is driven by a human drive force and an assist force generated by a prime mover 24. It should be noted that the carrying vehicle 100 is capable of traveling only by either the human drive force or the drive force generated by the prime mover 24. A variety of vehicles, including a cage cart, a cart, a stretcher, a wheelchair, and so forth, are examples of the carried vehicle. The carrying vehicle 100 includes a carrying vehicle body 2 and the clamp device 4.

### Carrying Vehicle Body

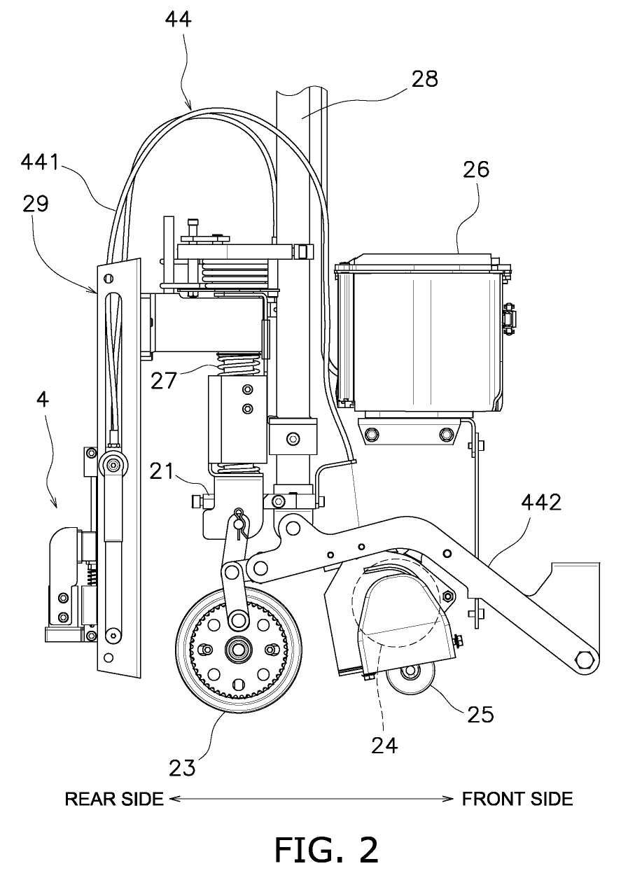

FIG. 2 is a side view of the carrying vehicle 100 from which a frame 21 of the carrying vehicle body 2 shown in FIG. 1 is detached in part for illustrative purposes. As shown in FIGS. 1 and 2, the carrying vehicle body 2 includes the frame 21, a drive wheel 23, the prime mover 24, one or more driven wheels 25, a battery 26, an urging member 27, a handle post 28, and an arm 29.

The handle post 28 is attached to the frame 21. The handle post 28 is configured to receive the human drive force forwardly or rearwardly inputted thereto by a user. For example, a handle to be held by the user is attached to a distal end portion of the handle post 28.

The drive wheel 23, the prime mover 24, the one or more driven wheels 25, the battery 26, the urging member 27, the handle post 28, and the arm 29 are attached to the frame 21. The drive wheel 23 is driven by the prime mover 24. The prime mover 24 is, for instance, an electric motor. The prime mover 24 is supplied with electricity from the battery 26.

The urging member 27 is configured to urge the drive wheel 23 downward. The urging member 27 is disposed between the arm 29 and the drive wheel 23. The urging member 27 urges the arm 29 and the drive wheel 23 such that the arm 29 and the drive wheel 23 are separated away from each other. The urging member 27 is attached at the upper end thereof to the arm 29, while being attached at the lower end thereof to the frame 21. The urging member 27 is configured to urge the drive wheel 23 downward through the frame 21. The urging member 27 is, for instance, a coil spring.

The arm 29 is attached to the frame 21. The arm 29 is movable with respect to the frame 21 in an up-and-down direction. The arm 29 is attached to the carrying vehicle body 2 in a manner to be pivotable in a horizontal direction.

### Clamp Device

The clamp device 4 is attached to the carrying vehicle body 2. When described in detail, the clamp device 4 is attached to the arm 29. The clamp device 4 is attached to the arm 29 in a manner to be adjustable in positions in the up-and-down direction. For example, the clamp device 4 is fixed to the arm 29 by a plurality of bolts, a quick release lever, or so forth and is made movable with respect to the arm 29 in the up-and-down direction by loosening the bolts, the quick release lever, or so forth.

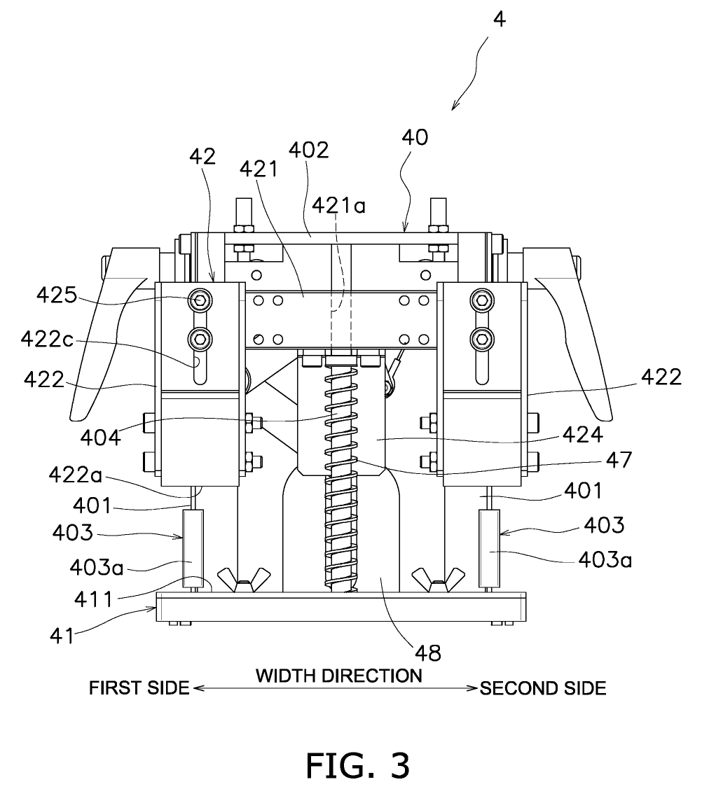

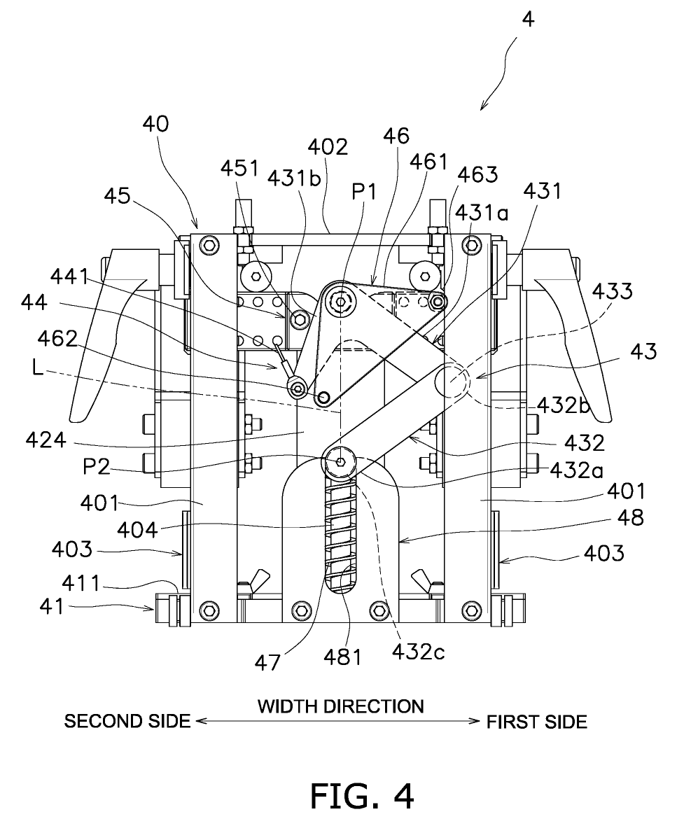

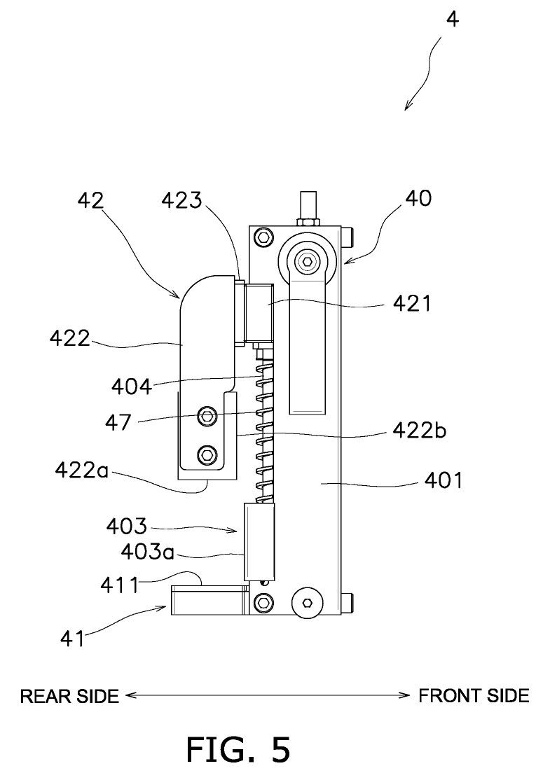

FIG. 3 is a front view of the clamp device 4 seen from the rear side; FIG. 4 is a rear view of the clamp device 4 seen from the front side; FIG. 5 is a side view of the clamp device 4. FIGS. 3 to 5 show the clamp device 4 by which an object has not been clamped.

As shown in FIGS. 3 to 5, the clamp device 4 is configured to clamp a part of the carried vehicle (i.e., an object). The clamp device 4 clamps an outer peripheral part of the carried vehicle. The clamp device 4 includes a base unit 40, a first clamp member 41, a second clamp member 42, a toggle mechanism 43, an operating member 44, a lock mechanism 45, an unlock mechanism 46, an urging member 47, and a guide member 48.

### Base Unit

The base unit 40 includes a pair of vertical frames 401, a transverse frame 402, a pair of holding members 403, and a pillar 404. The base unit 40 is attached to the arm 29 in a manner to be adjustable in positions in the up-and-down direction.

The pair of vertical frames 401 is disposed apart from each other at an interval in the width direction. The pair of vertical frames 401 extends in the up-and-down direction. The transverse frame 402 extends in the width direction. The transverse frame 402 couples the pair of vertical frames 401 therethrough to each other. When described in detail, the transverse frame 402 couples the upper ends of the pair of vertical frames 401 therethrough to each other.

The pair of holding members 403 is attached to the pair of vertical frames 401 on a one-to-one correspondence. Each holding member 403 includes a first holding surface 403a. The first holding surface 403ais oriented or located rearward relative to its respective vertical frame 401. The first holding surface 403a orthogonally extends relative to a pressure receiving surface 411 (to be described). In other words, the first holding surface 403aextends in both the up-and-down direction and the width direction.

The pillar 404 extends in the up-and-down direction. The pillar 404 couples the first clamp member 41 and the transverse frame 402 therethrough to each other. The pillar 404 is disposed between the pair of vertical frames 401 in the width direction. The pillar 404 has a columnar shape.

### First Clamp Member

The first clamp member 41 is fixed to the base unit 40. In other words, the first clamp member 41 is attached to the base unit 40 in an immovable manner. The first clamp member 41 is moved unitarily with the base unit 40.

The first clamp member 41 extends between the pair of vertical frames 401 in the width direction. The first clamp member 41 couples the pair of vertical frames 401 therethrough to each other. The first clamp member 41 couples the lower ends of the pair of vertical frames 401 therethrough to each other.

The first clamp member 41 includes the pressure receiving surface 411. The pressure receiving surface 411 is oriented upward or located on top of the first clamp member 41. The pressure receiving surface 411 extends in both the width direction and a back-and-forth, i.e., front-and-back direction.

### Second Clamp Member

The second clamp member 42 is attached to the base unit 40 in a manner to be movable in the up-and-down direction. The second clamp member 42 includes a slider 421, a pair of clamp bodies 422, a pair of spacers 423, and an attachment plate 424.

The slider 421 is attached to the base unit 40 in a manner to be movable up and down. When described in detail, the slider 421 includes a through hole 421a penetrating therethrough in the up-and-down direction. Further, the pillar 404 of the base unit 40 penetrates the through hole 421a. The slider 421 extends in the width direction. The slider 421 is in contact at both ends thereof with the pair of vertical frames 401 on a one-to-one correspondence.

The pair of clamp bodies 422 is attached to both ends of the slider 421, respectively. When described in detail, the pair of clamp bodies 422 is attached to the slider 421 through the pair of spacers 423. The pair of clamp bodies 422 is fastened to the slider 421 by bolts 425.

The pair of clamp bodies 422 is attached to the slider 421 in a manner to be adjustable in positions in the up-and-down direction. When described in detail, each clamp body 422 includes a slit 422c extending in the up-and-down direction. The bolts 425 are screwed into the slider 421 through the slit 422c. Due to this configuration, each clamp body 422 is adjustable in positions in the up-and-down direction in range extending along the slit 422c.

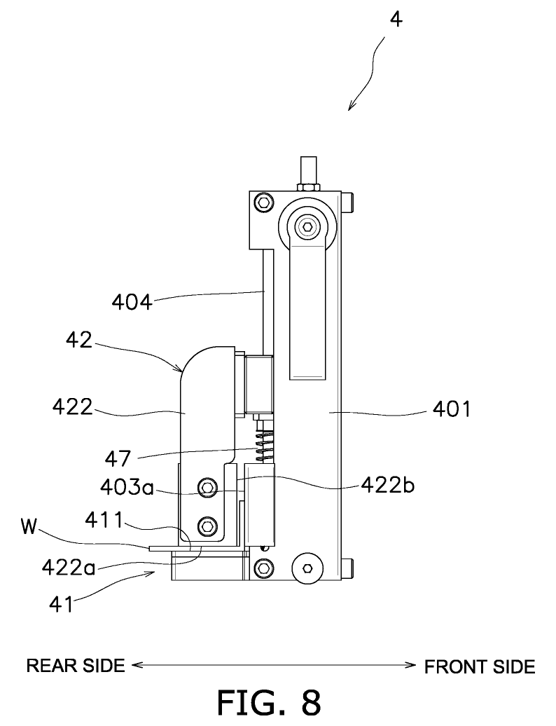

Each clamp body 422 includes a pressure applying surface 422a. The pressure applying surface 422a is oriented downward, i.e., located on the bottom of the second clamp member 42. The pressure applying surface 422ais opposed to the pressure receiving surface 411. As seen in FIG. 8, the object (W), composing a part of the carried vehicle, is clamped by the pressure applying surfaces 422a and the pressure receiving surface 411 so that the carrying vehicle 100 and the carried vehicle are joined to each other.

Each clamp body 422 includes a second holding surface 422b. The second holding surface 422b is oriented forward relative to the second clamp member 42. The second holding surface 422bextends to be orthogonal to the pressure applying surface 422a. When the clamp device 4 is set in the clamping state, the second holding surface 422b is opposed to the first holding surface 403a corresponding thereto at an interval.

Referring to FIGS. 3, 5, and 8, each spacer 423 is disposed between the slider 421 and each clamp body 422 in the front-rear direction. Each clamp body 422 and each spacer 423 are attached to the slider 421 through the bolts 425. Because of this, each spacer 423 is made detachable from the slider 421 and each clamp body 422. When each spacer 423 is replaced by another spacer different in thickness therefrom, it is possible to change the magnitude of a gap between the first and second holding surfaces 403a and 422b. Because of this, when the object W is disposed between the first and second holding surfaces 403a and 422b, any of the objects with various thickness settings is enabled to be disposed as the object W by replacing each spacer 423 with another spacer with a corresponding thickness setting.

The attachment plate 424 is attached to the slider 421. The attachment plate 424 is moved unitarily with the slider 421. The attachment plate 424 extends downward from the slider 421. The attachment plate 424 is disposed in front of the pillar 404.

### Urging Member

The urging member 47 urges the second clamp member 42 such that the pressure applying surfaces 422a are separated away from the pressure receiving surface 411. Specifically, the urging member 47 urges the second clamp member 42 upward.

The urging member 47 is disposed between the first and second clamp members 41 and 42 in the up-and-down direction. When described in detail, the urging member 47 is disposed between the first clamp member 41 and the slider 421. The urging member 47 is, for instance, a coil spring. The urging member 47 is extendable and compressible in the up-and-down direction. The urging member 47 is supported by the pillar 404. When described in detail, the pillar 404 extends inside the urging member 47 in the up-and-down direction.

### Guide Member

Referring to FIGS. 3 and 4, the guide member 48 is attached to the base unit 40 in an immovable manner. Specifically, the guide member 48 is attached to the base unit 40 through the first clamp member 41. The guide member 48 extends upward from the first clamp member 41. The guide member 48 may be directly attached to the base unit 40.

The guide member 48 is disposed on the front side with respect to the attachment plate 424. Further, the guide member 48 is disposed on the front side with respect to the first clamp member 41. The guide member 48 has a plate shape. The guide member 48 includes a guide groove 481. The guide groove 481 extends in the up-and-down direction. The guide groove 481 opens upward.

### Toggle Mechanism

The toggle mechanism 43 is configured to move the second clamp member 42 up and down. The toggle mechanism 43 includes a first link 431, a second link 432, and a joint 433.

The first link 431 is attached to the base unit 40 in a pivotable manner. When described in detail, the first link 431 is attached to the transverse frame 402 in a pivotable manner. The first link 431 is pivotable about a first pivot axis P1. The first pivot axis P1 is located in a center part of the transverse frame 402.

The first link 431 includes a first arm 431a and a second arm 431b. The first and second arms 431a and 431b are integrated with each other as a single member or a unitary one-piece member.

The first arm 431a extends from the first pivot axis P1 and is joined to a second end portion 432b of the second link 432 through the joint 433.

The second arm 431b extends from the first pivot axis P1 in a different extending direction from the first arm 431a. Because of this, the first link 431 has an L shape. The first and second arms 431a and 431b extend in directions orthogonal to the first pivot axis P1. An angle formed by the first and second arms 431a and 431b is not particularly limited to a specific value; however, the angle falls in a range of, for instance, 75 to 105 degrees and is preferably approximately 90 degrees. The second arm 431b is smaller in length than the first arm 431a.

The second link 432 is attached to the second clamp member 42 in a pivotable manner. When described in detail, the second link 432 is attached to the attachment plate 424 in a pivotable manner. The second link 432 is pivotable about a second pivot axis P2. The second pivot axis P2 is disposed immediately below the first pivot axis P1 in the up-and-down direction. An imaginary line, drawn by connecting the first and second pivot axes P1 and P2, will be referred to as an imaginary reference line L.

The second link 432 includes a first end portion 432a and the second end portion 432b. The first end portion 432a is attached to the second clamp member 42 in a pivotable manner. The second end portion 432b is joined to the first link 431 through the joint 433.

The second link 432 includes a protruding portion 432c. The protruding portion 432c is disposed on the first end portion 432a of the second link 432. The protruding portion 432c protrudes toward the guide member 48. The protruding portion 432c extends along the second pivot axis P2. The protruding portion 432c extends inside the guide groove 481. The protruding portion 432c is joined to the attachment plate 424. The protruding portion 432c is moved up and down along the guide groove 481 inside the guide groove 481.

The joint 433 joins the first and second links 431 and 432 therethrough to each other. The joint 433 is movable in both the up-and-down direction and the width direction. When the clamp device 4 is in an unclamping state, the joint 433 is disposed on the first side of the imaginary reference line L in the axial direction.

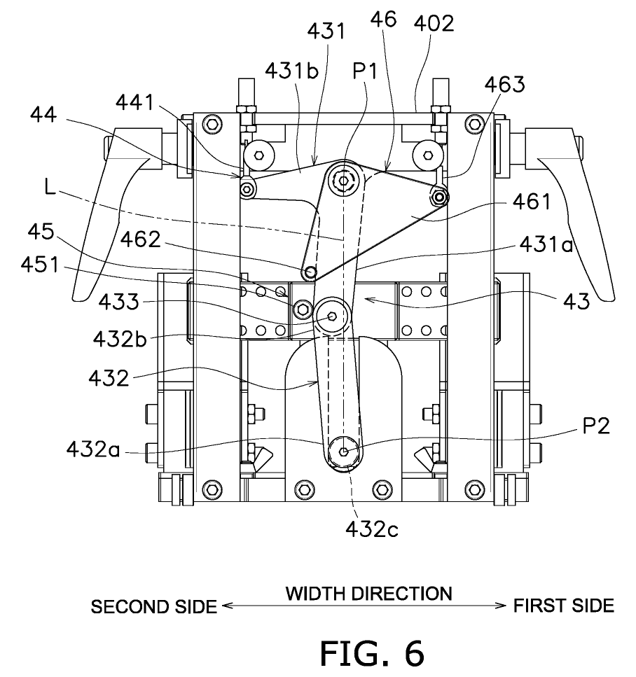

FIG. 6 is a rear view of the clamp device 4 by which the object W has been clamped. As shown in FIGS. 4 and 6, the toggle mechanism 43 is switchable between an actuated state and an unactuated state. It should be noted that FIG. 4 shows the unactuated state of the toggle mechanism 43, whereas FIG. 6 shows the actuated state of the toggle mechanism 43.

As shown in FIGS. 3 and 4, when set in the unactuated state, the toggle mechanism 43 moves the second clamp member 42 upward such that the pressure applying surfaces 422a are separated away from the pressure receiving surface 411. Accordingly, the pressure applying surfaces 422a are released from pressing the pressure receiving surface 411 so that the first and second clamp members 41 and 42 are released from clamping the object W.

When the toggle mechanism 43 is set in the unactuated state, the joint 433 is disposed on the first side of the imaginary reference line L in the width direction. The first link 431 is not restricted from pivoting so as to move the joint 433 to the first side; in other words, the first link 431 is not restricted from pivoting in a first pivot direction (counterclockwise in FIGS. 4 and 6). Because of this, the first end portion 432a of the second link 432 is made movable to approach the first pivot axis P1; hence, the second clamp member 42 is moved upward and the pressure applying surfaces 422a are released from pressing the pressure receiving surface 411.

As shown in FIGS. 6 and 8, when set in the actuated state, the toggle mechanism 43 moves the second clamp member 42 downward so that the pressure applying surfaces 422a are caused to press the pressure receiving surface 411. It should be noted that the pressure applying surfaces 422a press the pressure receiving surface 411 through the object W. Accordingly, the object W is clamped by the first and second clamp members 41 and 42.

When the toggle mechanism 43 is set in the actuated state, the joint 433 is disposed either on the imaginary reference line L or on the second side of the imaginary reference line L in the width direction. The first link 431 is restricted from pivoting so as not to move the joint 433 to the second side; in other words, the first link 431 is restricted from pivoting in a second pivot direction (clockwise in FIGS. 4 and 6) by the operating member 44, the lock mechanism 45, or so forth. Because of this, the first end portion 432a of the second link 432 cannot move to approach the first pivot axis P1 and the pressure receiving surface 411 is pressed by the pressure applying surfaces 422a. As a result, it is possible to clamp the object W by the first and second clamp members 41 and 42.

### Operating Member

As shown in FIGS. 1, 2, 4, and 6, the operating member 44 is configured to pivot the first link 431. The operating member 44 pivots the first link 431 such that the toggle mechanism 43 is turned to the actuated state. In other words, the operating member 44 pivots the first link 431 about the first pivot axis P1 in the second pivot direction (clockwise in FIGS. 4 and 6).

The operating member 44 is attached to a distal end portion of the second arm 431b of the first link 431. The operating member 44 includes, for instance, a wire 441 and a foot lever 442. The wire 441 is attached to the distal end portion of the second arm 431b of the first link 431. The foot lever 442 is configured to pull the wire 441. The foot lever 442 is attached to the frame 21 of the carrying vehicle body 2 in a pivotable manner. The wire 441 is attached to the foot lever 442.

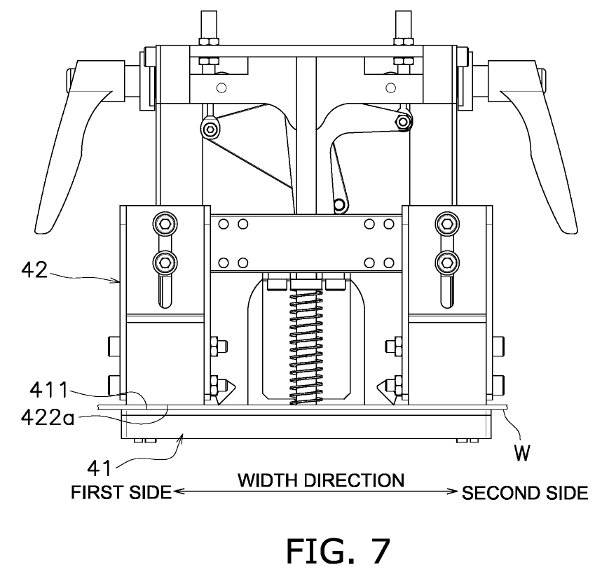

When a distal end portion (a right end portion in FIG. 2) of the foot lever 442 is trodden down, the foot lever 442 is pivoted, whereby the wire 441 attached to the foot lever 442 is pulled. When the wire 441 is pulled, the first link 431 is pivoted in the second pivot direction (clockwise in FIGS. 4 and 6). Accordingly, the joint 433 is disposed either on the imaginary reference line L or on the second side of the imaginary reference line L in the width direction, whereby the toggle mechanism 43 is turned to the actuated state. Consequently, as shown in FIGS. 7 and 8, the second clamp member 42 is moved downward and the pressure applying surfaces 422a press the pressure receiving surface 411 through the object W. It should be noted that, when the object W has an L-shaped cross section, a portion thereof extending in the horizontal direction is clamped by the pressure applying surfaces 422a and the pressure receiving surface 411, while a portion thereof extending in the up-and-down direction is disposed in the gaps between the first holding surfaces 403a and the second holding surfaces 422b.

### Lock Mechanism

As shown in FIGS. 3, 4, and 6, the lock mechanism 45 is configured to keep the toggle mechanism 43 in the actuated state. A stopper portion 451 is provided to serve as the lock mechanism 45. The stopper portion 451 is fixed to the second clamp member 42. When described in detail, the stopper portion 451 is fixed to the slider 421. The stopper portion 451 protrudes forward from the slider 421.

The stopper portion 451 contacts a member protruding rearward from either the first link 431 or the second link 432, e.g., the joint 433, so that the first link 431 is restricted from pivoting so as not to move the joint 433 from the imaginary reference line L to the second side; in other words, the first link 431 is restricted from pivoting in the second pivot direction (clockwise in FIGS. 4 and 6). Accordingly, even when the wire 441 is cut, for instance, the toggle mechanism 43 is kept in the actuated state.

### Unlock Mechanism

The unlock mechanism 46 is configured to pivot the first link 431 such that the joint 433, disposed either on the imaginary reference line L or on the second side of the imaginary reference line L in the width direction, is moved to the first side of the imaginary reference line L in the width direction. In other words, the unlock mechanism 46 is configured to pivot the first link 431 in the first pivot direction (counterclockwise in FIGS. 4 and 6).

The unlock mechanism 46 includes a pivot plate 461, a protruding portion 463, and an operating portion 463. The pivot plate 461 is attached to the base unit 40 in a manner to be pivotable about the first pivot axis P1.

The protruding portion 462 protrudes rearward from the pivot plate 461. The protruding portion 462 is disposed on the second side of the first link 431 in the width direction. When the pivot plate 461 is pivoted in the first pivot direction (counterclockwise in FIGS. 4 and 6), the protruding portion 462 contacts the first link 431.

The operating portion 463 is configured to pivot the pivot plate 461 about the first pivot axis P1 in the first pivot direction (counterclockwise in FIGS. 4 and 6). The operating portion 463 is, for instance, a wire. When a lever attached to the handle is operated by the user, for instance, the wire serving as the operating portion 463 is pulled, whereby the pivot plate 461 is pivoted in the first pivot direction (counterclockwise in FIGS. 4 and 6). As a result, the protruding portion 462 contacts the first link 431, whereby the first link 431 is pivoted in the first pivot direction (counterclockwise in FIGS. 4 and 6). Accordingly, the joint 433 is moved to the first side of the imaginary reference line L in the width direction so that the toggle mechanism 43 is turned to the unactuated state.

### Modifications

One preferred embodiment of the present invention has been explained above. However, the present invention is not limited to the above, and a variety of changes can be made without departing from the gist of the present invention. It should be noted that basically speaking, respective modifications to be described are applicable simultaneously.
(a) In the preferred embodiment described above, the first clamp member 41 is disposed below the second clamp member 42; however, the clamp device 4 is not limited in configuration to this. For example, the first clamp member 41 may be disposed above the second clamp member 42. More specifically, the clamp device 4 may be inverted in the up-and-down direction.
(b) In the preferred embodiment described above, the first link 431 includes the first arm 431a and the second arm 431b; alternatively, the first link 431 may not include the second arm 431b.
(c) In the preferred embodiment described above, the second clamp member 42 includes the pair of clamp bodies 422; however, the number of the clamp bodies 422 is not limited to this. For example, the second clamp member 42 may include one clamp body 422, or alternatively, may include three or more clamp bodies 422.
(d) In the preferred embodiment described above, the wire 441 for pulling the first link 431 is provided as the operating member 44; however, a component provided as the operating member 44 is not limited to the wire 441 as long as pivoting of the first link 431 is enabled by the component. For example, an actuator such as a motor for pivoting the first link 431 may be provided as the operating member 44.
(e) The carrying vehicle body 2 is not limited to that explained in the preferred embodiment described above; for instance, an AMR (autonomous mobile robot), an AVG (automated guided vehicle), or so forth may be provided as the carrying vehicle body 2.

### LIST OF REFERENCE NUMERALS

2: Carrying vehicle body, 23: Drive wheel, 24: Prime mover, 4: Clamp device, 40: Base unit, 403a: First holding surface, 41: First clamp member. 411: Pressure receiving surface, 42: Second clamp member, 421: Slider, 422: Clamp body, 422a: Pressure applying surface, 422b: Second holding surface, 423: Spacer, 43: Toggle mechanism, 431: First link, 431a: First arm, 431b: Second arm, 432: Second link, 432a: First end portion, 432b: Second end portion, 432c: Protruding portion, 433: Joint, 44: Operating member, 411: Wire, 45: Lock mechanism, 451: Stopper portion, 46: Unlock mechanism, 47: Urging member, 48: Guide member, 481: Guide groove, 100: Carrying vehicle, L: Imaginary reference line, P1: First pivot axis, P2: Second pivot axis

1. A clamp device comprising:
a base unit having upward, downward, front, rear, first, and second sides;
a first clamp member including a pressure receiving surface oriented upward or downward, the first clamp member attached to the base unit in an immovable manner;
a second clamp member including a pressure applying surface opposed to the pressure receiving surface, the second clamp member attached to the base unit in a manner to be movable up and down relative to the base unit; and
a toggle mechanism configured to move the second clamp member up and down.

2. The clamp device according to claim 1, wherein the toggle mechanism includes
a first link attached to the base unit in a pivotable manner,
a second link attached to the second clamp member in a pivotable manner, and
a joint joining the first and second links therethrough to each other.

3. The clamp device according to claim 2, wherein
the second link includes a first end portion and a second end portion, the first end portion attached to the second clamp member in a pivotable manner, the second end portion joined to the first link through the joint, and
the first link includes a first arm and a second arm, the first arm extending from a first pivot axis of the first link, the first arm joined to the second end portion of the second link through the joint, the second arm extending from the first pivot axis in a different extending direction from the first arm.

4. The clamp device according to claim 3, further comprising:
an operating member attached to a distal end portion of the second arm, the operating member configured to pivot the first link.

5. The clamp device according to claim 2, further comprising:
an operating member configured to pivot the first link.

6. The clamp device according to claim 2, wherein
the toggle mechanism is switchable between an actuated state and an unactuated state, the toggle mechanism causing the pressure applying surface to press the pressure receiving surface when set in the actuated state, the toggle mechanism releasing the pressure applying surface from pressing the pressure receiving surface when set in the unactuated state,
the joint is disposed on a first side of an imaginary reference line when the toggle mechanism is set in the unactuated state, the imaginary reference line defined as an imaginary line connecting a first pivot axis of the first link and a second pivot axis of the second link, and
the joint is disposed either on the imaginary reference line or on a second side of the imaginary reference line when the toggle mechanism is set in the actuated state.

7. The clamp device according to claim 6, further comprising:
a lock mechanism configured to keep the toggle mechanism in the actuated state.

8. The clamp device according to claim 7, wherein the lock mechanism includes a stopper portion configured to restrict the first link from pivoting in a direction so as not to move the joint from the imaginary reference line to the second side.

9. The clamp device according to claim 8, further comprising:
an unlock mechanism configured to allow the first link to pivot in another direction so as to move the joint to the first side of the imaginary reference line.

10. The clamp device according to claim 2, further comprising:
a guide member including a guide groove extending in an up-and-down direction, the guide member attached to the base unit in an immovable manner, wherein
the second link includes a protruding portion configured to be moved along the guide groove in the up-and-down direction.

11. The clamp device according to claim 1, further comprising:
an urging member urging the second clamp member such that the pressure applying surface is separated away from the pressure receiving surface.

12. The clamp device according to claim 1, wherein
the base unit includes a first holding surface extending to be orthogonal to the pressure receiving surface, and
the second clamp member includes a second holding surface opposed to the first holding surface at an interval.

13. The clamp device according to claim 1, wherein the second clamp member includes a slider, a clamp body, and a spacer, the slider attached to the base unit in a manner to be movable up and down, the clamp body including the pressure applying surface, the spacer disposed between the clamp body and the slider, the spacer attached to the clamp body and the slider in a manner to be detachable therefrom.

14. The clamp device according to claim 1, wherein the second clamp member includes a slider and a clamp body, the slider attached to the base unit in a manner to be movable up and down, the clamp body including the pressure applying surface, the clamp body attached to the slider in a manner to be adjustable in a position in an up-and-down direction.

15. A carrying vehicle comprising:
a carrying vehicle body including a prime mover and a drive wheel; and
the clamp device recited in claim 1, the clamp device attached to the carrying vehicle body.

16. The clamp device according to claim 3, further comprising:
an operating member configured to pivot the first link.

17. The clamp device according to claim 3, wherein
the toggle mechanism is switchable between an actuated state and an unactuated state, the toggle mechanism causing the pressure applying surface to press the pressure receiving surface when set in the actuated state, the toggle mechanism releasing the pressure applying surface from pressing the pressure receiving surface when set in the unactuated state,
the joint is disposed on a first side of an imaginary reference line when the toggle mechanism is set in the unactuated state, the imaginary reference line defined as an imaginary line connecting a first pivot axis of the first link and a second pivot axis of the second link, and
the joint is disposed either on the imaginary reference line or on a second side of the imaginary reference line when the toggle mechanism is set in the actuated state.

18. The clamp device according to claim 3, further comprising:
a guide member including a guide groove extending in an up-and-down direction, the guide member attached to the base unit in an immovable manner, wherein
the second link includes a protruding portion configured to be moved along the guide groove in the up-and-down direction.

19. The clamp device according to claim 2, further comprising:
an urging member urging the second clamp member such that the pressure applying surface is separated away from the pressure receiving surface.

20. The clamp device according to claim 2, wherein
the base unit includes a first holding surface extending to be orthogonal to the pressure receiving surface, and
the second clamp member includes a second holding surface opposed to the first holding surface at an interval.
